(19) United States
(12) Patent Application Publication
(10) Pub. No.: US 2014/0092356 A1
(43) Pub. Date: Apr. 3, 2014

(54) CURVED DISPLAY DEVICE

(71) Applicant: SAMSUNG DISPLAY CO., LTD., Yongin-City (KR)

(72) Inventors: Byung Wook AHN, Seoul (KR); Dong-Wook KIM, Asan-si (KR); Keun Chan OH, Cheonan-si (KR); Cheong Hun LEE, Asan-si (KR); Yu Deok SEO, Hwaseong-si (KR); Min Su KIM, Seoul (KR); Jang-Hyun KIM, Hwaseong-si (KR)

(73) Assignee: Samsung Display Co., Ltd., Yongin-City (KR)

(21) Appl. No.: 13/829,653

(22) Filed: Mar. 14, 2013

(30) Foreign Application Priority Data
Oct. 2, 2012 (KR) 10-2012-0109719

(51) Int. Cl. G02F 1/1339

(52) U.S. Cl. CPC G02F 1/1339
USPC 349/153

(57) ABSTRACT

A curved display device includes a bent first substrate and a bent second substrate spaced apart and facing each other, a sealant positioned at edges of the first substrate and the second substrate, and a liquid crystal layer interposed between the first substrate and the second substrate and contained by the sealant, wherein the first substrate and the second substrate are bent to have almost the same curvature radius, and a modulus of elasticity of the sealant, at least when bending of the bent first and second substrates occurs, is about 1 MPa to about 100 MPa and more specifically about 1 MPa to about 50 MPa so that the sealant can be easily shear deformed during the bending process.

### CROSS-REFERENCE TO RELATED APPLICATION

This application claims priority to and the benefit of Korean Patent Application No. 10-2012-0109719 filed in the Korean Intellectual Property Office on Oct. 2, 2012, the entire contents of which application are incorporated herein by reference.

### BACKGROUND

(a) Field of Disclosure

The present disclosure of invention relates to curved display devices.

(b) Description of Related Technology

A liquid crystal display (LCD) is one of the most common types of flat panel displays currently in use. It typically includes two flat display panels provided with field generating electrodes such as a pixel electrode and a common electrode, and a liquid crystal layer interposed therebetween. The liquid crystal display generates an electric field extending through the liquid crystal layer by applying a corresponding voltage across the field generating electrodes. This determines the orientation direction of liquid crystal molecules of the liquid crystal layer and controls polarization of incident light passing through the liquid crystal, thus displaying a desired image.

The liquid crystal display is often used as a display device of a television receiver. Market trends have led to the size of the TV monitor increasing over time. As the size of the flat panel liquid crystal display is increased, there is a growing problem in that a difference in views is experienced between the case where a viewer is disposed head on with the center of a monitor and the case where the viewer is disposed to watch from a left or right end side of the monitor.

One solution is to use curved rather than flat panel liquid crystal displays (LCDs). A curved display device may be formed by curving the display device in a concave type or convex type in order to compensate the difference between views. The display device may be a portrait type where a vertical height is larger than a horizontal width length and a monitor is bent about a vertical axis, or a landscape type where a vertical height is smaller than a horizontal width and a monitor is bent about a horizontal axis.

However, in the case where the curved type is formed by curving the spaced apart panels (or substrates) of the liquid crystal display, a compressive force may be applied to at least one of the substrates positioned in the curvature by a sealant surrounding edges of the two substrates of the liquid crystal display. This may strain at least one of the substrates so that the two substrates are not identically curved about a common central axis. When it happens that the two spaced apart substrates are not identically curved relative to a common center of curvature, a gap between the two substrates, that is, a cell gap, may not be constant. In that case; where the cell gap of the liquid crystal display device is not constant over the display area, a display quality may be deteriorated.

It is to be understood that this background of the technology section is intended to provide useful background for understanding the here disclosed technology and as such, the technology background section may include ideas, concepts or recognitions that were not part of what was known or appreciated by those skilled in the pertinent art prior to corresponding invention dates of subject matter disclosed herein.

### SUMMARY

The present disclosure of invention provides a curved display device that is configured to prevent deterioration of a display quality due to nonuniformity of a cell gap between bent first and second substrates of the device, where the nonuniformity can occur if one of the first and second substrates buckles while being bent into its respective bent shape.

An exemplary embodiment includes: a bent first substrate and a bent second substrate spaced apart from and facing each other, a sealant positioned at edges of the first substrate and the second substrate, and a liquid crystal layer interposed between the first substrate and the second substrate and contained by the sealant, wherein the first substrate and the second substrate are bent to have almost the same curvature radius, and a modulus of elasticity (MoE) of the sealant is about 1 MPa to about 100 MPa and more specifically about 1 MPa to about 50 MPa at least during the bending process where the first and second substrates are bent to acquire their respective bent states.

The sealant may be shear deformed and may have a non-rectangular cross section.

A cell gap between the first substrate and the second substrate may be almost constant.

The second substrate may be positioned on an inside based on a center of the curvature radius, and the second substrate may not be compressed in a horizontal direction as compared to the first substrate.

The curved display device may further include a curved and rigid fixing member configured for positionally fixing ends of the first substrate and the second substrate.

The first substrate and the second substrate may include a first display region and a second display region, and the curvature radius of the first display region and the curvature radius of the second display region may be different from each other.

The curvature radius of the first display region may be larger than the curvature radius of the second display region, and the first display region may be positioned at edges of the first substrate and the second substrate.

The second display region may be positioned at central portions of the first substrate and the second substrate, the first substrate and the second substrate may further include a third display region positioned between the first display region and the second display region, and the third display region may have a curvature radius that is different from the curvature radius of the first display region and the curvature radius of the second display region.

The curvature radius of the third display region may be smaller than the curvature radius of the first region and may be larger than the curvature radius of the second display region.

According to an exemplary embodiment, a curved display device can include a shear deformed sealant having a modulus of elasticity (MoE) of a predetermined value or less, such that a sealant can be easily shear deformed by stress when a liquid crystal display in which the sealant is formed is bent to thereby become a curved liquid crystal display, whereby the easy shear deformability of the sealant allows the performing of the bending such that a cell gap between two substrates sealed by the sealant is substantially constant across display areas of the device. Accordingly, it is possible to prevent deterioration of a display quality due to nonuniformity of the cell gap, which may occur if there is buckling in the curved surfaces of the display device.

### BRIEF DESCRIPTION OF THE DRAWINGS

FIG. 1 is a perspective view of a curved display device according to an exemplary embodiment.

FIG. 2 is a cross-sectional view of the curved display device shown in FIG. 1.

FIGS. 3 and 4 are a concept view for describing a change in substrate and sealant when the display device is bent.

FIG. 5 is a perspective view of a curved display device according to another exemplary embodiment in accordance with the present disclosure of invention.

FIG. 6 is a cross-sectional view of the curved display device shown in FIG. 5.

FIG. 7 is a perspective view of a curved display device according to another exemplary embodiment.

FIG. 8 is a cross-sectional view of the curved display device shown in FIG. 7.

FIG. 9 is a cross-sectional view of a curved display device according to another exemplary embodiment.

FIG. 10 is an exploded perspective view showing an example of the curved display device according to an exemplary embodiment.

FIG. 11 is an exploded perspective view showing another exemplary embodiment.

FIG. 12 is an exploded perspective view showing another example of a curved display device.

FIG. 13 is an exploded perspective view showing another example of a curved display device.

### DETAILED DESCRIPTION

The present disclosure of invention will be provided more fully hereinafter with reference to the accompanying drawings, in which exemplary embodiments in accordance with the present teachings are shown. As those skilled in the art would realize in view of this disclosure, the described embodiments may be modified in various different ways, all without departing from the spirit or scope of the present teachings.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

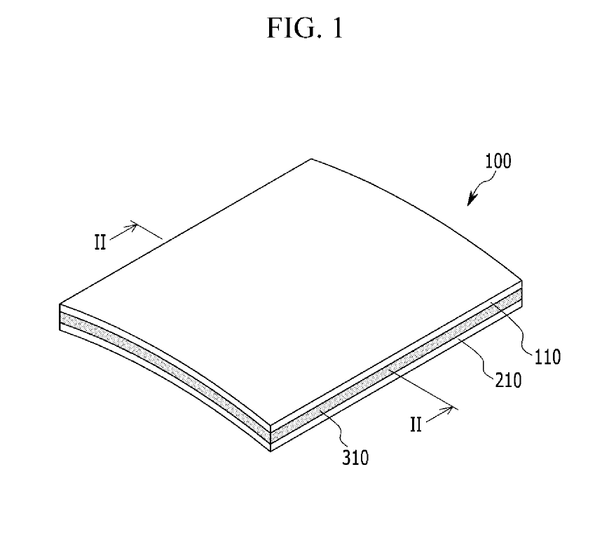

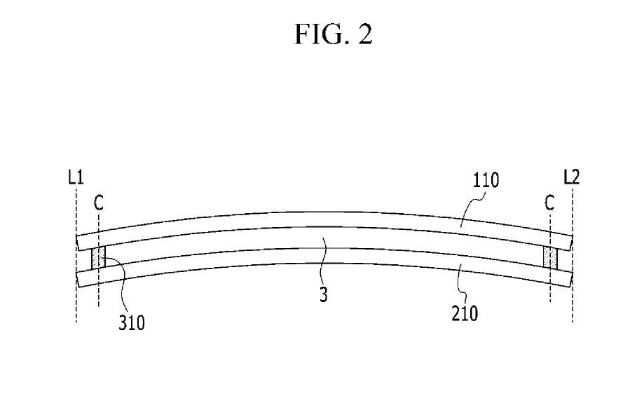

First, referring to FIGS. 1 and 2, a curved display device according to a first exemplary embodiment will be described. FIG. 1 is a perspective view of the curved display device and FIG. 2 is a cross-sectional view taken through line II-II.

Referring to FIGS. 1 and 2, the curved display device according to the present exemplary embodiment includes a display unit 100 including a first substrate 110 and a spaced apart second substrate 210 facing the first and a liquid crystal layer 3 positioned between the two substrates 110 and 210. An edge ringing sealant 310 is provided along the edges of the first substrate 110 and the second substrate 210 to seal the liquid crystal material in its interior. Additionally, the first substrate 110 and the second substrate 210 are bonded to each other by the sealant 310. In other words, the sealant 310 combines with the first and second substrates to cage the liquid crystal layer 3 between the first substrate 110 and the second substrate 210 and inside the interior portion of the ring-shaped sealant.

Although not shown in the drawings, the curved display device may further include one or more fixing members configured for fixing the shapes of the first substrate 110 and of the second substrate 210 to have a predetermined curvature relative to a predetermined common axis of curvature. This will be described in more detail for another exemplary embodiment discussed later below.

As shown in FIGS. 1 and 2, the first substrate 110 and the second substrate 210 of the curved display device according to the present exemplary embodiment are bent so as to have predetermined circular curvatures relative to a common central axis. A user of the display faces the portion concavely curving in a horizontal direction (left and right directions of the observer). More specifically, the user faces the display device from the side of the second substrate 210.

The first substrate 110 and the second substrate 210 are bent to have respective predetermined radii of curvature sharing a common center point or central axis. In this case, the center of the curvature radius in the horizontal direction is positioned below the second substrate 210 in FIG. 2, that is, at the side at which the user is positioned to observe the image displayed on the display.

The curved display device according to the present exemplary embodiment includes the sealant 310 positioned at the edges of the first substrate 110 and of the second substrate 210 so as to bond the first substrate 110 and the second substrate 210 to each other, where; at least at the time a bending process is performed, the sealant 310 has the modulus of elasticity of about 1 MPa to about 100 MPa (MegaPascals or N/mm²). In one subclass, the sealant 310 has a modulus of elasticity (MoE) of about 1 MPa to about 50 MPa. When configured like this (where the sealant 310 has a MoE of about 1 MPa to about 100 MPa and more preferably about 1 MPa to about 50 MPa), the sealant 310 can be easily shear deformed while a panel bending processing is performed so that the first substrate 110 and the second substrate 210 can have a common axis of curvature for their curved surfaces. The MoE may be increased (e.g., via photo-curing) after the bending process is performed.

Referring to FIG. 2, after the bending if performed on initially flat substrates, the sealant 310 is shear-wise deformed about an illustrated central line C that is parallel to imaginary lines L1 and L2 respectively touched by leftmost or rightmost ends of the second substrate 210 and of the first substrate 110.

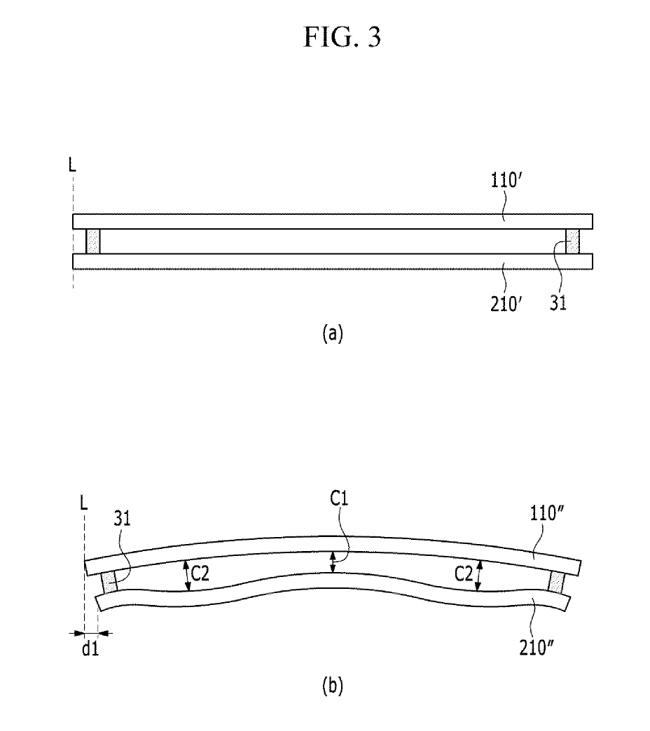

Accordingly, the first substrate 110 is positioned as a segment of an outer cylindrical shell (not shown) having a center corresponding to the center of the curvature radius and the second substrate 210 is positioned as a segment of an inner and coaxial cylindrical shell (not shown) also having a centeral axis corresponding to the desired curvature radius, thus maintaining the constant cell gap. Accordingly, because the material of the sealant ring 310 can shear into a non-rectangular parallelogram shaped cross section in accordance with the deformation shown in FIG. 2, it is possible to prevent deterioration of a display quality due to nonuniformity of the cell gap. More specifically, the second substrate 210 which is positioned in the inside based on the center of the curvature radius is not inwardly compressed in a horizontal direction as it would have been if the sealant ring 310 where share-wise rigid and maintained an initial rectangular cross sectional shape even as the first substrate 110 is bent inot the illustrated position based on the predetermined center of the curvature radius. (See also FIG. 3(b) which will be described shortly.)

Although not shown in the drawings, it is to be understood that signal lines such as display substrate gate lines and crossing therewith data lines are provided, and also that switching elements such as thin film transistors are provided and are connected to the signal lines, and then respective first field generating electrodes (a.k.a. pixel electrodes) are connected to the switching elements and that these may be formed on the first substrate 110. A light blocking member, a color filter, and a second field generating electrode may be formed on the second substrate 210. However, both the first field generating electrodes and one or more second field generating electrodes (e.g., common electrodes) may be both formed on the first substrate 110. Further, at least one of the color filter and the light blocking member may be formed on the first substrate 110.

The liquid crystal layer 3 which is injected between the first substrate 110 and the second substrate 210 may include any one of or all types of liquid crystal materials known in the art, such as a TN (twisted nematic) mode, a VA (vertical aligned) mode, an IPS (in plane switching) mode, and a BP (blue phase) mode.

Further, although not shown in the drawings, an initial LC aligning, alignment layer may be included in at least one of the first substrate 110 and the second substrate 210, and the alignment layer may be rubbed in a predetermined direction or optically aligned so that the LC molecules have an initial alignment when an electric field is not present. Alternatively, at least one of the liquid crystal layer 3 and the alignment layer may include a photopolymerization material.

The width of the cross section of the sealant 310 may be about 2.00 mm or less.

The materials of the sealant 310 may include a resin, an initiator, and a filler. The resin may include at least one of an acryl resin, an epoxy resin, and a urethane resin, and the initiator may include at least one of a photoinitiator absorbing light of a visible light region or light of an ultraviolet ray region or a thermal initiator performing a reaction by heat. In one embodiment, activation of the initiator is controlled so that at least during the bending process the sealant 310 has the modulus of elasticity of about 1 MPa to about 100 MPa (MegaPascals or N/mm²) rather than substantially more. For example, the photoinitiator may be an initiator absorbing light of the visible light region of 400 nm or more, and may be composed of one or more oximes. The filler may include a core shell particle, an inorganic-based panel type filler, and the like. The sealant composition is selectively adjusted and controllably cured so that, at least during the bending process, the sealant 310 has the aforementioned MoE of about 1 MPa to about 100 MPa and more preferably about 1 MPa to about 50 MPa. More generally, when batches of display devices are sealed and bent, samples of the batch sealant composition can be pre-subjected to different curing and/or compositional constraints and empirically tested for their responsive MoE's developed under the respective different curing and/or compositional constraints and then the one or more constraints that produce the desired MoE or range of MoE's is used for the corresponding manufacturing line batch of display devices so as to obtain the desired MoE or range of MoE's.

Next, referring to FIGS. 3 and 4, a change in substrate and sealant when the display device is bent and the sealant is too rigid will be described.

FIG. 3 shows the case of the display device including the sealant having relatively high modulus of elasticity (MoE>>100 MPa) is used. FIG. 4 shows the comparative case of the display device including a sealant in accordance with the present disclosure and having a relatively low modulus of elasticity (MoE<100 MPa), for example, a modulus of elasticity of about 1 MPa to about 100 MPa, whereby the initially rectangular cross section of the sealant can easily warp into a non-rectangular parallelogram shape when the curved display device according to the exemplary embodiment of the present disclosure is bent.

First, referring to FIG. 3(a), the illustrated example starts off as having a planar first substrate 110′ and a planar second substrate 210′ facing each other, and a relatively rigid (nonelastic) first sealant 31 that has a rectangular cross section bonding the first substrate 110′ and the second substrate 210′ to each other. As shown in FIG. 3(a), the first substrate 110′ and the second substrate 210′ bonded to each other by the first sealant 31 have originally (before a bending process is carried out) flat surfaces. The flat surfaces of the first substrate 110′ and the second substrate 210′ are disposed to be vertical to an imaginary vertical line L. Like this, the result obtained by applying the bending processing to the display device having the flat surface is shown in FIG. 3(b).

As described above, in the comparative display device whose sealant 31 is substantially rigid, the initially planar first substrate 110′ and the initially planar second substrate 210′ are bonded to each other as such by the relatively rigid first sealant 31 having the high modulus of elasticity (MoE>>100 MPa). Accordingly, the first substrate 110′ and the second substrate 210′ are firmly fixed at their surface points that interface with the relatively rigid first sealant 31 so as not to be changed in terms of relative positions thereof based on the first sealant 31. Like this, in the case where the first substrate 110′ and the second substrate 210′ are subjected to a bending process, so as to respectively become the illustrated first substrate 110″ and second substrate 210″ of FIG. 3(b), the second substrate 210″ may buckle in response to received tension. In other words, the second substrate 210″ buckles because it receives compressive forces through the substantially non-elastic sealant 31. Accordingly, as shown in FIG. 3(b), the outer edge of the second substrate 210″ is forced inwardly of the corresponding outer edge of the first substrate 110″ by a first gap distance d1 as measured relative to imaginary vertical line L″. That is, specifically, the second substrate 210″ positioned in the inside based on the center of the curvature radius is compressed in a horizontal direction and becomes non-smoothly deformed as compared to the first substrate 110″ positioned in the outside based on the center of the curvature radius.

Like this, according to the compressive force applied to the second substrate 210″, in the gap between the first substrate 110″ and the second substrate 210″, that is, in the cell gap, a portion having a second cell gap C2 that is wider than a first cell gap C1 at the center thereof is formed.

A difference between the cell gaps causes deterioration of a display quality.

Then, referring to FIG. 4, the result of bending processing of the display device according to the exemplary embodiment of the present disclosure will be described.

As shown in FIG. 4(a), the display device according to the exemplary embodiment of the present invention includes the first substrate 110 and the second substrate 210 facing each other, and the sealant 310 bonding the first substrate 110 and the second substrate 210 to each other. As described above, at least at the time of the bending process, the sealant 310 has the relatively low modulus of elasticity, for example, the modulus of elasticity of about 1 MPa to about 100 MPa.

In the case where the first substrate 110 and the second substrate 210 bonded to each other by the sealant 310 having the relatively low modulus of elasticity, for example, the modulus of elasticity of about 1 MPa to about 100 MPa are subjected to the being processing, the sealant 310 can elastically (or plastically) deform without losing its sealing properties according to the bending forces applied to the first substrate 110 positioned in the outside based on the center of the curvature radius and the corresponding compression forces applied to the second substrate 210 positioned in the inside based on the center of the curvature radius. Specifically, the sealant is shear deformed (without losing its sealing properties) in a direction of force applied to a lower portion and an upper portion of the sealant 310 to have a central line C that is parallel to the imaginary vertical line L. Accordingly, the sealant 310, as shown in FIG. 4(b), is deformed in a form that is similar to a non-rectangular parallelogram, and the first substrate 110 positioned in the outside based on the center of the curvature radius and the second substrate 210 positioned in the inside based on the center of the curvature radius may be constantly bent to have the same curvature radius. Accordingly, the first substrate 110 and the second substrate 210 have almost the same curved form. Specifically, the second substrate 210 positioned in the inside based on the center of the curvature radius is not caused to buckle when it is compressed in a horizontal direction as compared to the first substrate 110 positioned in the outside based on the center of the curvature radius.

Therefore, the cell gap between the first substrate 110 and the second substrate 210 may be constantly maintained, and deterioration of the display quality according to nonuniformity of the cell gaps, which may occur in the curved display device may be prevented.

Next, referring to the here-included Table 1, the bending experiment result of the curved display device according to the modulus of elasticity (MoE) of the sealant of the display device according to one Experimental Example of the present disclosure will be described. In the present Experimental Example, two substrates that were the same as each other were bonded by respective sealants having, at the time of bending, different moduli of elasticity (MoE's), and then subjected to bending processing to have the curvature radius of about 3.7 m (meters). The cell gap measured before the bending processing was about 3 μm, and conditions other than the modulus of elasticity of the sealant were the same. After the curved display device was manufactured by performing bending processing of each display device, an angle (θ) between the aforementioned imaginary vertical line L and an imaginary second line through which the edges of the two substrate are connected was measured, and described in the following Table. Furthermore, a change according to the position of the cell gap of the curved display device was measured, a maximum value thereof is described in the following Table, and a maximum value of a misalignment difference between two substrates facing each other in the curved display device was measured and described in the following Table.

TABLE 1

| | Modulus of elasticity (MPa) | | | | | | |
|---|---|---|---|---|---|---|---|
| | 50 | 100 | 200 | 400 | 600 | 800 | 1000 |
| Angle (θ) | −3.455 | 1.106 | 3.380 | 4.465 | 4.795 | 4.941 | 5.018 |
| Maximum difference | 216.754 | 234.559 | 236.287 | 236.037 | 235.945 | 235.913 | 235.904 |
| value of cell gaps (nm) | | | | | | | |
| Misalignment | 35.557 | 35.391 | 35.306 | 35.261 | 35.245 | 35.236 | 35.230 |
| maximum value (μm) | | | | | | | |

Referring to Table 1, in the case where the modulus of elasticity of the sealant bonding the two substrates at the time of bending is about 1 MPa to about 100 MPa (and more specifically, at around 50 Mpa) like the curved display device according to the exemplary embodiment of the present disclosure, it can be seen from the Table that the angle (θ) between the imaginary vertical line L and the imaginary second line through which the edges of the two substrates are connected is significantly reduced relative to the case where the MoE is around 1000 MPa. Theoretically speaking, a near zero angle should be findable (with further experimentation) somewhere between the tested 50 MPa run and the tested 100 MPa run. This means that a difference between positions of the edge of the substrate positioned in the outside based on the center of the curvature radius and the edge of the substrate positioned in the inside based on the center of the curvature radius is reduced in the case where the modulus of elasticity of the sealant is about 50 MPa to about 100 MPa. For example, in the case where the modulus of elasticity of the sealant is about 200 MPa or more, like an example shown in FIG. 3(b), the edge of the second substrate 210 positioned in the inside based on the center of the curvature radius is shorter than the edge of the first substrate 110 positioned in the outside based on the center of the curvature radius by the first gap d1 based on the imaginary vertical line L. Furthermore, it can be seen that the angle (A) between the imaginary vertical line L and the imaginary second line through which the edges of the two substrates are connected is increased as the modulus of elasticity of the sealant is increased, which means that the first gap d1 representing a difference between positions of the edge of the second substrate 210 positioned in the inside based on the center of the curvature radius and the edge of the first substrate 110 positioned in the outside based on the center of the curvature radius based on the imaginary vertical line L is increased. That is, it means that since compressive force applied to the second substrate 210 positioned in the inside based on the center of the curvature radius is more increased, the region having the increased second cell gap C2 is widened or a difference between the cell gaps at any position is increased.

Referring to Table 1, in the case where the modulus of elasticity of the sealant bonding the two substrates is about 1 MPa to about 100 MPa like the curved display device according to the exemplary embodiment of the present disclosure, it can be seen that the maximum difference value between the cell gaps is reduced and a misalignment difference between the two substrates is not largely different from the case where the modulus of elasticity of the sealant is high.

Then, referring to Table 2, the bending experiment result of the curved display device according to the modulus of elasticity of the sealant of the display device according to one Experimental Example of the present invention will be described. In the present Experimental Example, two substrates that were the same as each other were bonded by the sealants having the different moduli of elasticity, and then subjected to bending processing to have the curvature radius of about 4.0 m, about 3.7 m, about 3.4 m, about 3.1 m, about 2.8 m, and about 2.5 m. The relatively constant cell gap measured before the bending processing was about 3 μm, and conditions other than the modulus of elasticity of the sealant were the same. For each case, after the curved display device was manufactured by performing the bending process of each display device, an angle (θ) between the aforementioned imaginary vertical line L and an imaginary second line through which the edges of the two substrate are connected was measured, and described in the following Table 2. Furthermore, a change between the cell gaps at random positions of the curved display device was measured and a maximum value of the change between the cell gaps at random positions is described in the following Table 3. In this case, the change between the cell gaps is represented by a nm unit.

TABLE 2

| | | Modulus of elasticity (MPa) | | | | | | | | | | |
|---|---|---|---|---|---|---|---|---|---|---|---|---|
| | | 30 | 40 | 50 | 60 | 70 | 80 | 100 | 200 | 500 | 800 | 1000 |
| Curvature | 4.0 | −8.41 | −5.06 | −3.06 | −1.65 | −0.67 | −0.01 | 1.16 | 3.20 | 4.32 | 4.56 | 4.62 |
| radius (m) | 3.7 | −9.31 | −5.60 | −3.53 | −1.95 | −0.89 | −0.18 | 1.24 | 3.40 | 4.66 | 4.84 | 5.02 |
| | 3.4 | −10.39 | −6.36 | −3.95 | −2.22 | −1.04 | −0.29 | 1.26 | 3.61 | 5.08 | 5.18 | 5.34 |
| | 3.1 | −11.67 | −7.19 | −4.53 | −2.59 | −1.27 | −0.48 | 1.31 | 3.88 | 5.56 | 5.58 | 5.80 |
| | 2.8 | −13.24 | −8.21 | −5.23 | −3.03 | −1.55 | −0.70 | 1.38 | 4.20 | 6.16 | 6.07 | 6.37 |
| | 2.5 | −15.06 | −9.40 | −6.05 | −3.55 | −1.89 | −0.96 | 1.47 | 4.58 | 6.85 | 6.65 | 7.03 |

Referring to Table 2, in the case where the modulus of elasticity of the sealant bonding the two substrates is about 1 MPa to 100 MPa like the curved display device according to the exemplary embodiment of the present invention, it can be seen that even though the curvature radius is changed, the angle (θ) between the imaginary vertical line L and the imaginary second line through which the edges of the two substrates are connected is significantly reduced (as compared for example to the case of MoE being around 1000 MPa). This means that a difference between positions of the edge of the substrate positioned in the outside based on the center of the curvature radius and the edge of the substrate positioned in the inside based on the center of the curvature radius is small even though the curvature radius is changed in the case where the modulus of elasticity of the sealant is about 1 MPa to 100 MPa. On the other hand, in the case where the modulus of elasticity of the sealant is about 200 MPa or more, like an example shown in FIG. 3(b), it can be seen that the edge of the second substrate 210″ positioned in the inside based on the center of the curvature radius is shorter than the edge of the first substrate 110″ positioned in the outside based on the center of the curvature radius by the first gap d1 based on the imaginary vertical line L, and that the first gap d1 is increased as the modulus of elasticity of the sealant is increased. That is, it means that since compressive force applied to the second substrate 210″ positioned in the inside based on the center of the curvature radius is more increased, the region having the increased second cell gap C2 is widened or a difference between the cell gaps is increased.

TABLE 3

| Curvature | Modulus of elasticity (MPa) | | | | | | | | | | |
|---|---|---|---|---|---|---|---|---|---|---|---|
| radius (m) | 30 | 40 | 50 | 60 | 70 | 80 | 100 | 200 | 500 | 800 | 1000 |
| 4.0 | 132.851 | 162.920 | 175.515 | 181.495 | 184.645 | 186.644 | 187.729 | 188.422 | 189.938 | 189.779 | 132.851 |
| 3.7 | 160.871 | 200.333 | 216.744 | 224.800 | 229.379 | 231.993 | 233.552 | 234.554 | 235.942 | 235.902 | 160.871 |
| 3.4 | 195.354 | 247.568 | 269.139 | 280.021 | 286.669 | 290.321 | 292.517 | 293.960 | 295.303 | 295.501 | 195.354 |
| 3.1 | 241.209 | 311.515 | 340.388 | 355.284 | 364.979 | 370.281 | 373.375 | 375.461 | 376.851 | 377.452 | 241.209 |
| 2.8 | 303.302 | 399.888 | 439.339 | 460.077 | 474.362 | 482.317 | 486.706 | 489.754 | 491.377 | 492.660 | 303.302 |
| 2.5 | 380.997 | 511.937 | 565.197 | 593.577 | 613.987 | 625.611 | 631.687 | 636.013 | 638.066 | 640.315 | 380.997 |

Referring to Table 3, in the case where the modulus of elasticity of the sealant bonding the two substrates is about 1 MPa to 100 MPa like the curved display device according to the exemplary embodiment of the present invention, it can be seen that the maximum difference value between the cell gaps is reduced as compared to the case where the modulus of elasticity of the sealant is higher than about 200 MPa even though the curvature radius is changed.

Like this, in the case of the curved display device where the modulus of elasticity of the sealant positioned at the edges of the two substrates facing each other to bond two substrates is about 1 MPa to about 100 MPa like the curved display device according to the exemplary embodiment of the present invention, it can be seen that the two substrates may be constantly (smoothly) bent to have substantially the same curvature radius, the cell gap between the two substrates may be constantly maintained, and deterioration of the display quality according to nonuniformity of the cell gaps, which may occur in the curved display device, may be prevented.

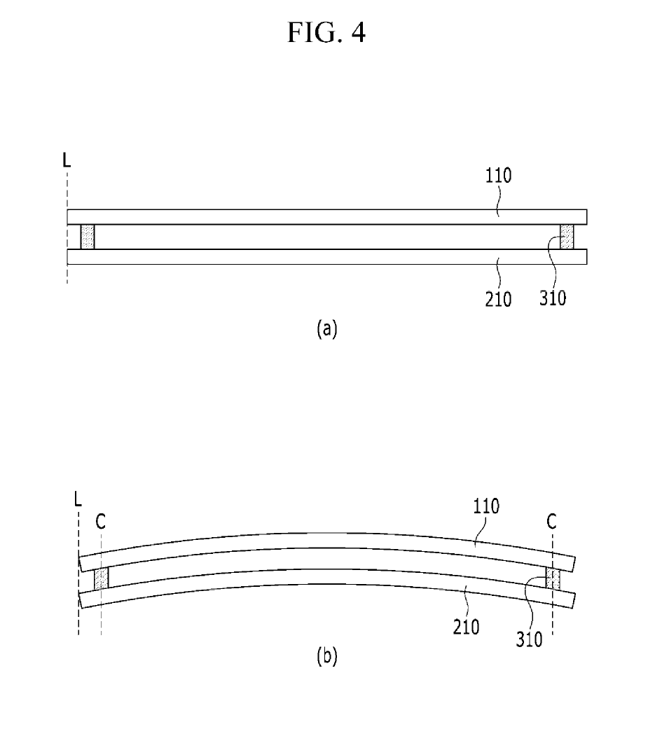

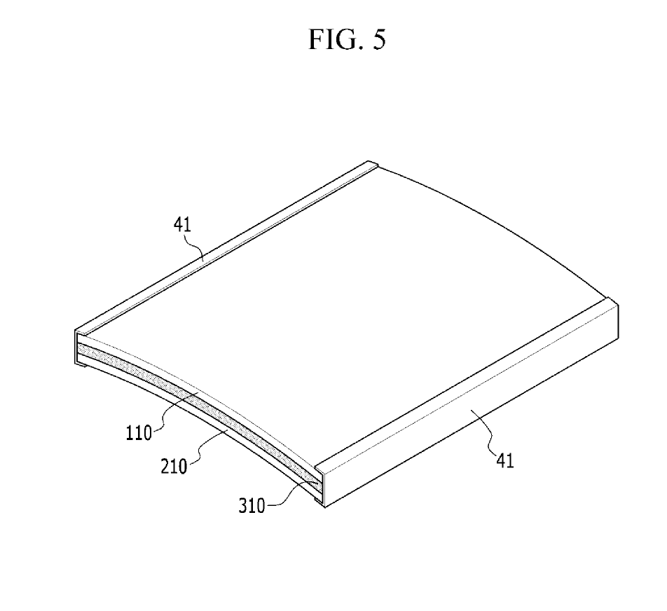

Next, referring to FIGS. 5 and 6, the curved display device according to another exemplary embodiment in accordance with the present disclosure will be described. FIG. 5 is a perspective view of a curved display device according to this other exemplary embodiment and FIG. 6 is a cross-sectional view of the curved display device shown in FIG. 5.

Referring to FIGS. 5 and 6, the curved display device according to the present exemplary embodiment is almost similar to the curved display device according to the exemplary embodiment shown in FIGS. 1 and 2. A detailed description of the similar constituent elements will thus be omitted.

However, unlike the curved display device according to the exemplary embodiment described with reference to FIGS. 1 and 2, the curved display device according to the present exemplary embodiment further includes a pair of fixing members 41 respectively positioned at opposed edges of the first substrate 110 and the second substrate 210.

The fixing members 41 serve to fix the positional relations of both sides of the concavely curved display device in a horizontal direction after bending in a manner that allows the first substrate 110 and the second substrate 210 to have substantially the same curvature such that the cell gap dimension is substantially constant and uniform across the areas of the bent substrates 110 and 210.

It is possible to prevent misalignment between the two substrates 110 and 210 after they are bent inot the desired positional state by fixing the ends of both sides of the two substrates 110 and 210 by the relatively rigid fixing members 41 so that the relative positions of the two substrates 110 and 210 are not changed after bending and despite the relatively low modulus of elasticity of the sealant 310 that may be maintained after bending.

Like the curved display device according to the exemplary embodiment described with reference to FIGS. 1 and 2, the first substrate 110 and the second substrate 210 of the curved display device according to the present exemplary embodiment are bent to have a substantially constant curvature. An observer recognizes a portion concavely curving in a horizontal direction (left and right directions of the observer). Specifically, the observer recognizes the image of the display device from the side of the second substrate 210.

The first substrate 110 positioned in the outside based on the center of the curvature radius and the second substrate 210 positioned in the inside based on the center of the curvature radius are constantly and smoothly bent to have the substantially same curvature radius so that cell gap is uniform across the display area. In this case, the center of the curvature radius in the horizontal direction is positioned outside the second substrate 210, that is, at the side at which the observer is positioned.

The curved display device according to the present exemplary embodiment includes the sealant 310 positioned at the edges of the first substrate 110 and the second substrate 210 to bond the first substrate 110 and the second substrate 210 to each other, and the sealant 310 has the modulus of elasticity of about 1 MPa to about 100 MPa and more specifically about 1 MPa to about 50 MPa. Like this, the sealant 310 has the modulus of elasticity of about 1 MPa to about 100 MPa, and thus, the sealant 310 can be shear deformed at least while the bending processing is performed so that the first substrate 110 and the second substrate 210 will have smoothly curved surfaces and not buckled surfaces. Accordingly, the first substrate 110 positioned in the outside based on the center of the curvature radius and the second substrate 210 positioned in the inside based on the center of the curvature radius may be constantly bent to have the same curvature radius, thus maintaining the constant cell gap over the display area. Accordingly, it is possible to prevent deterioration of a display quality according to nonuniformity of the cell gap, may occur in the curved display device.

All characteristics of the curved display device according to the exemplary embodiment and Experimental Example described with reference to FIGS. 1 to 4 and Table 1 can be applied to the curved display device according to the present exemplary embodiment of FIGS. 4-5.

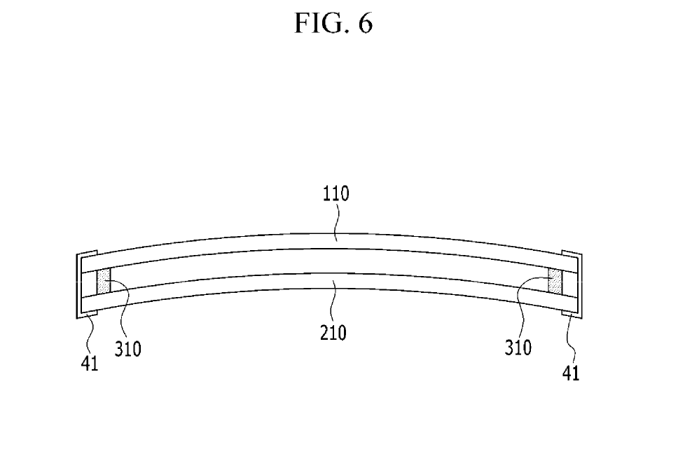

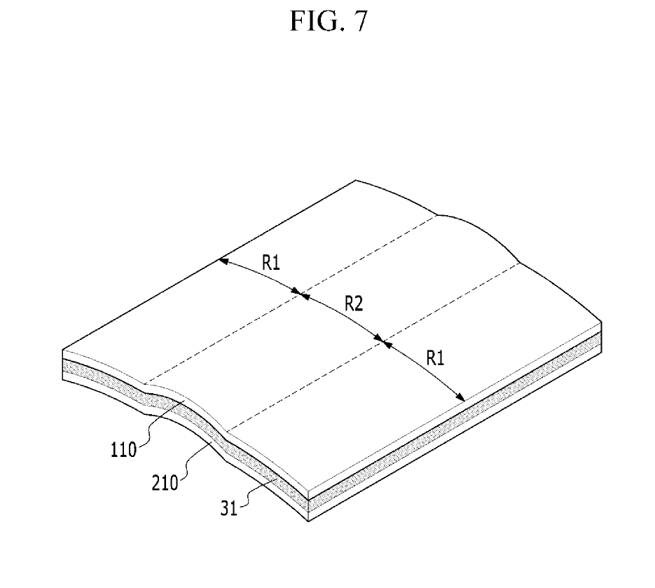

Next, referring to FIGS. 7 and 8, the curved display device according to yet another exemplary embodiment in accordance with the present teachings will be described. FIG. 7 is a perspective view of a curved display device according to the yet another exemplary embodiment and FIG. 8 is a cross-sectional view of the curved display device shown in FIG. 7.

Referring to FIGS. 7 and 8, the curved display device according to the present exemplary embodiment is almost similar to the curved display device according to the exemplary embodiment shown in FIGS. 1 and 2. A detailed description of the similar constituent elements will be omitted.

However, unlike the curved display device according to the exemplary embodiment described with reference to FIGS. 1 and 2, the curved display device according to the present, yet another exemplary embodiment includes regions having different curvature radii. Specifically, an edge portion R1 of the curved display device has a first curvature radius, and a central portion R2 of the curved display device has a different second curvature radius. The first curvature radius may be larger than the second curvature radius. That is, the curvature radius may be increased as going away from the central portion of the curved display device. For example, the first curvature radius of the edge portion R1 may be about 7,000 mm to about 15,000 mm, and the second curvature radius of the central portion R2 may be about 1,000 mm to about 7,000 mm.

Like this, if the curvature radius is formed to be larger at the edge of the curved display device and the curvature radius is formed to be smaller at the central portion, the deformation force applied to the edge of the display device while the bending process is performed will be smaller than the force applied to the more greatly bent central portion of the display device. Generally, the central portion of the display device can be made relatively stronger to thermal stress and to mechanical stress, while the edge portion of the display device tends to be relatively weak to thermal stress and mechanical stress. Accordingly, the edge portion of the display device which is relatively weak to thermal stress and mechanical stress may be bent to have the larger curvature radius, thus reducing a change amount of the cell gap according to thermal stress and mechanical stress. Accordingly, it is possible to prevent deterioration of the display quality according to a change in cell gap of the curved display device by using different radii of curvature for different portions of the display area.

Like the curved display device described with reference to FIGS. 1 and 2 according to the exemplary embodiment, the first substrate 110 and the second substrate 210 of the curved display device according to the present exemplary embodiment are bent to have substantially same curvatures in respective facing positions thereof even if the radii of curvature change over the gross area of the display.

The first substrate 110 positioned in the outside based on the center of the curvature radius and the second substrate 210 positioned in the inside based on the center of the curvature radius are smoothly bent to have substantially the same curvature radii in respective facing portion of the first and second substrates 110 and 210. In this case, the center of the curvature radius in the horizontal direction is positioned outside the second substrate 210, that is, at the side at which the observer is positioned.

The curved display device according to the present exemplary embodiment includes the sealant 310 positioned at the edges of the first substrate 110 and the second substrate 210 to bond the first substrate 110 and the second substrate 210 to each other, and the sealant 310 has the modulus of elasticity of about 1 MPa to about 100 MPa and more specifically about 1 MPa to about 50 MPa at least at the time the bending process is carried out. Like this, the sealant 310 has the modulus of elasticity of about 1 MPa to about 100 MPa, and thus the sealant 310 can be shear deformed while the bending processing is being performed so that the first substrate 110 and the second substrate 210 have smoothly curved surfaces rather than buckled surfaces. Accordingly, the first substrate 110 positioned in the outside based on the center of the curvature radius and the second substrate 210 positioned in the inside based on the center of the curvature radius may be constantly bent to have substantially the same curvature radius for facing portion thereof, thus maintaining the constant cell gap. Accordingly, it is possible to prevent deterioration of a display quality according to nonuniformity of the cell gap, may occur in the curved display device.

All characteristics of the curved display device according to the exemplary embodiment and Experimental Example described with reference to FIGS. 1 to 4 and Table 1 and all characteristics of the curved display device according to the exemplary embodiment described with reference to FIGS. 5 and 6 can be applied to the curved display device according to the present exemplary embodiment.

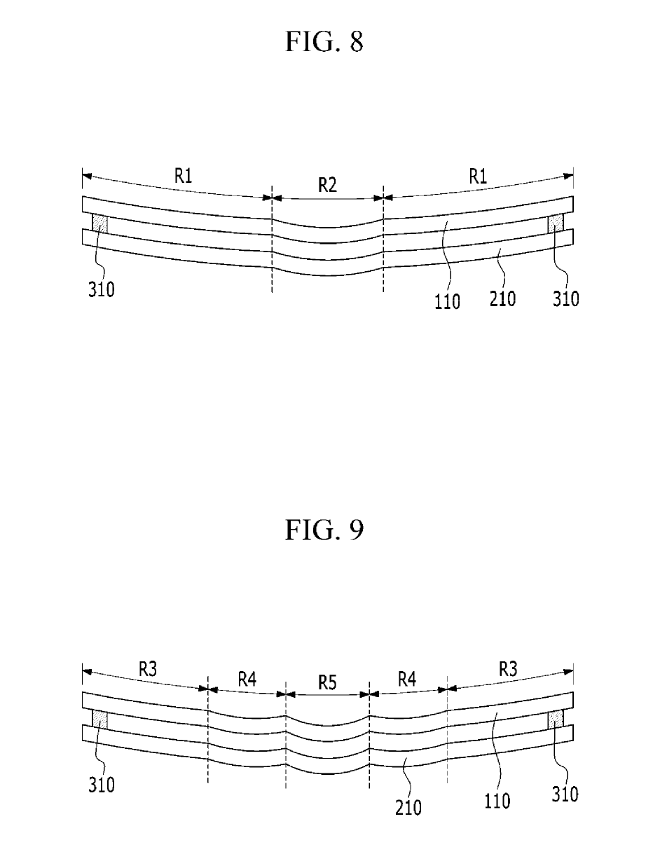

For sake of simplified explanation, the curved display device according to the 8 present exemplary embodiment of FIG. 7—is shown to have just two different curvature radii at the edge portion R1 and the central portion R2, but the regions having different curvature radii may be various rather than just two. An example of this will be described with reference to FIG. 9. FIG. 9 is a cross-sectional view of a curved display device according to another exemplary embodiment of the present invention.

Referring to FIG. 9, the curved display device according to the present exemplary embodiment is similar to the curved display device according to the exemplary embodiment described with reference to FIGS. 7 and 8. However, the curved display device according to the present exemplary embodiment includes a first region R3, a second region R4, and a third region R5 respectively having different curvature radii. The first region R3 is positioned at the edge of the curved display device, the third region R5 is positioned at the central portion of the curved display device, and the second region R4 is positioned between the first region R3 and the third region R5. The curvature radius of the curved display device is largest in the first (outermost) region R3 and smallest in the third (innermost) region R5. Further, the curvature radius of the second (intermediate) region R4 is smaller than the curvature radius of the first region R3 and larger than the curvature radius of the third region R5.

Like this, if the curvature radius is formed to be largest at the edge of the curved display device and the curvature radius is minutely formed as going toward the central portion, the deformation force applied to the edge of the display device while bending process is performed will be smaller than the force applied to the central portion of the display device. Accordingly, the edge portion of the display device which tends to be relatively weak to thermal stress and mechanical stress may be bent to have the largest curvature radius, thus reducing a change amount of the cell gap there according to thermal stress and mechanical stress. Accordingly, it is possible to prevent deterioration of the display quality according to a change in cell gap of the curved display device.

Like the curved display device described with reference to FIGS. 1 and 2 according to the exemplary embodiment, the first substrate 110 and the second substrate 210 of the curved display device according to the present exemplary embodiment are bent to have the same curvature according to the position.

The first substrate 110 positioned in the outside based on the center of the curvature radius and the second substrate 210 positioned in the inside based on the center of the curvature radius are constantly bent to have the same curvature radius. In this case, the center of the curvature radius in the horizontal direction is positioned outside the second substrate 210, that is, at the side at which the observer is positioned.

The curved display device according to the present exemplary embodiment includes the sealant 310 positioned at the edges of the first substrate 110 and the second substrate 210 to bond the first substrate 110 and the second substrate 210 to each other, and the sealant 310 has the modulus of elasticity of about 1 MPa to about 100 MPa at least during the bending process. Like this, the sealant 310 has the modulus of elasticity of about 1 MPa to about 100 MPa, and thus, the sealant 310 can be shear deformed while the bending processing is performed so that the first substrate 110 and the second substrate 210 have smoothly curved surfaces rather than buckled ones. Accordingly, the first substrate 110 positioned in the outside based on the center of the curvature radius and the second substrate 210 positioned in the inside based on the center of the curvature radius may be constantly bent to have substantially the same curvature radius in respective facing portion thereof, thus maintaining the constant cell gap. Accordingly, it is possible to prevent deterioration of a display quality according to nonuniformity of the cell gap, may occur in the curved display device.

All characteristics of the curved display device according to the exemplary embodiment and Experimental Example described with reference to FIGS. 1 to 4 and Table 1 and all characteristics of the curved display device according to the exemplary embodiment described with reference to FIGS. 5 and 6 can be applied to the curved display device according to the present exemplary embodiment.

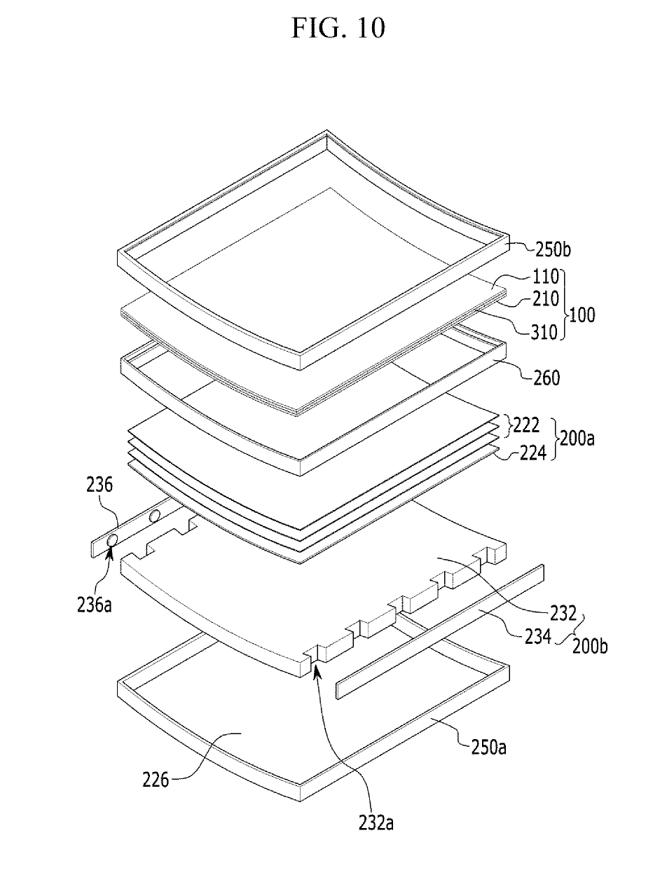

Next, referring to FIG. 10, an example of the curved display device according to the exemplary embodiment of the present invention will be described. FIG. 10 is an exploded perspective view showing an example of the curved display device according to the exemplary embodiment of the present invention.

Referring to FIG. 10, the curved display device according to the present exemplary embodiment includes an edge type backlighting assembly.

More specifically, the curved display device according to the present exemplary embodiment includes the curved display unit 100 according to the exemplary embodiment shown in FIGS. 1 and 2, the backlight assembly, and the edge fixing members (e.g., four such fixing members joined to define upper and lower fixing frames.

In other words, the curved display unit 100 includes the first substrate 110 and the second substrate 210 facing each other, and the sealant 310 (having a MoE<about 100 MPa at least during bending) positioned along the edge of the first substrate 110 and the second substrate 210 to bond the first substrate 110 and the second substrate 210. The first substrate 110 and the second substrate 210 are bent to have one or more predetermined curvatures and a relatively constant cell gap.

The first substrate 110 positioned in the outside based on the center of the curvature radius and the second substrate 210 positioned in the inside based on the center of the curvature radius are constantly bent to have the same curvature radius. In this case, the center of the curvature radius in the horizontal direction is positioned outside the second substrate 210, that is, at the side at which the observer is positioned.

The sealant 310 has the modulus of elasticity of about 1 MPa to about 100 MPa and more specifically about 1 MPa to about 50 MPa. Like this, the sealant 310 has the modulus of elasticity of about 1 MPa to about 100 MPa, and thus, the sealant 310 can be shear deformed while the bending processing is being performed so that the first substrate 110 and the second substrate 210 have smoothly curved surfaces. Accordingly, the first substrate 110 positioned in the outside based on the center of the curvature radius and the second substrate 210 positioned in the inside based on the center of the curvature radius may be constantly bent to have the same curvature radius, thus maintaining the constant cell gap. Accordingly, it is possible to prevent deterioration of a display quality according to nonuniformity of the cell gap, may occur in the curved display device.

Like the display unit of the curved display device according to the exemplary embodiment described with reference to FIGS. 7 and 8, the regions having different curvature radii may be included according to the position of the curved display device, and the curvature radius may be increased as going toward the edge of the curved display device. Furthermore, the curved display device need be of a cylindrical curvature but may instead have a curvature corresponding to a spiral, a catenary, or a parabola.

Referring to FIG. 10 again, the backlighting assembly is positioned on a lower portion of the display unit 100 and provides light to the display unit 100. The backlight assembly shown in FIG. 10 is an edge type backlighting assembly, and may include a light source reinforcement member 200a including a diffuser sheet 224 and a plurality of optical sheets 222, a light source module 200b, and a reflector 226.

The light source reinforcement member 200a increases efficiency of light emitted from the light source module 200b.

The light source module 200b may include a curved light guide plate (cLGP) 232, a first printed circuit board (PCB) 234 supporting a corresponding plurality of first light sources (e.g., LED's not shown), a second printed circuit board (PCB) 236 supporting a corresponding plurality of second light sources 236a (e.g., LED's, shown).

The curved light guide plate 232 (hereafter also the cLGP 232) is bent to have the same one or more curvatures as that of the display unit 100. First grooves 232a are formed at positions corresponding to the first light sources on one side of the light guide (cLPGP) 232, and second grooves (not shown) are formed at positions corresponding to the second light sources 236a on another side of the light guide 232. However, at least one of the first grooves 232a or the second grooves may be omitted.

As mentioned, appropriate first light sources such as LED's are mounted on the first printed circuit board (PCB) 234. The first light sources are mounted on the first printed circuit board (PCB) 234 to emit desired intensities of white or differently colored lights at desired times when backlighting is to be provided (e.g., during respective frame or subframe periods).

Second light sources 236a are mounted on the second printed circuit board (PCB) 236. The second light sources are mounted on the second printed circuit board (PCB) 236 to emit light.

However, any one of the first light source and the second light source may be omitted. In this case, the light source is positioned along one surface of the light guide 232.

The diffuser sheet 224 is disposed on the light guide 232 to diffuse light by the light guide 232, thus emitting diffused light to the optical sheets 222.

The optical sheets 222 (e.g., prism sheets) are positioned on the diffuser sheet 224 to increase efficiency of light that is incident from the diffuser sheet 224.

An appropriately curved reflector 226 is disposed on a lower portion of the curved light guide 232 to reflect light that is incident from the light source module 200b, thus increasing efficiency of light.

The fixing member includes a curved bottom chassis 250a, a curved top chassis 250b, and a curved mold frame 260, and fixes the display unit 100 so that the display unit 100 is bent to have a predetermined one or more curvature radii as described above. Specifically, the bottom chassis 250a, the top chassis 250b, and the mold frame 260 that are the fixing members are bent to have the predetermined one or more curvature radii in correspondence to those of the respective display subareas of the display unit 100.

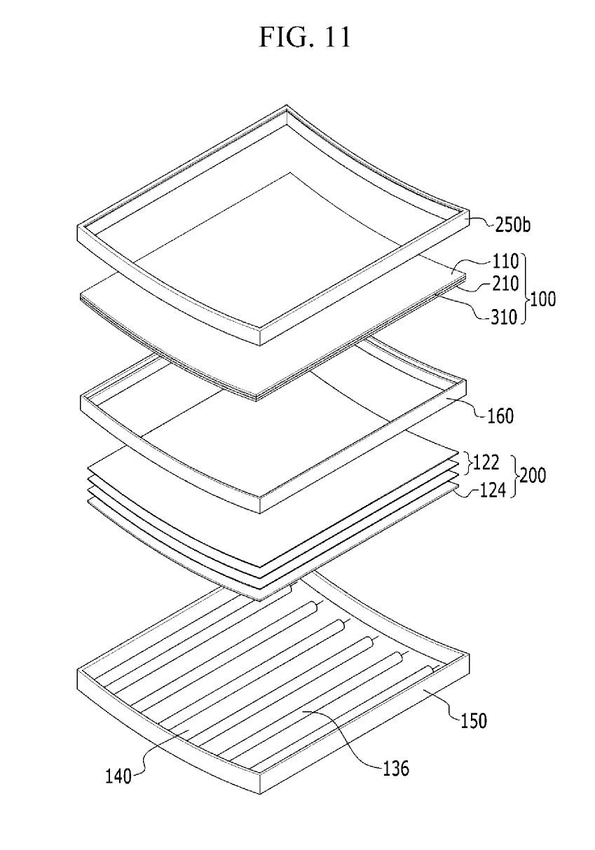

Next, referring to FIG. 11, an example of the curved display device according to a further exemplary embodiment will be described. FIG. 11 is an exploded perspective view showing another example of the curved display device according to the exemplary embodiment of the present invention.

Referring to FIG. 11, the curved display device according to the present exemplary embodiment includes a direct illumination type backlighting assembly.

Specifically, the curved display device according to the present exemplary embodiment includes the curved display unit 100 according to the exemplary embodiment shown in FIGS. 1 and 2, the backlight assembly, and the fixing member.

The curved display unit 100 includes the bent first substrate 110 and the bent second substrate 210 facing each other, and the sealant 310 positioned along the edge of the first substrate 110 and the second substrate 210 to bond the first substrate 110 and the second substrate 210. The first substrate 110 and the second substrate 210 are bent to have a predetermined one or more curvatures.

The first substrate 110 positioned in the outside based on the center of the curvature radius and the second substrate 210 positioned in the inside based on the center of the curvature radius are constantly bent to have the same curvature radius. In this case, the center of the curvature radius in the horizontal direction is positioned outside the second substrate 210, that is, at the side at which the observer is positioned.

The sealant 310 has the modulus of elasticity of about 1 MPa to about 100 MPa and more specifically about 1 MPa to about 50 MPa at least during the substrate bending process. Like this, the sealant 310 has the modulus of elasticity of about 100 MPa or less, and thus, the sealant 310 can be shear deformed while the bending processing is being performed so that the first substrate 110 and the second substrate 210 have smoothly curved surfaces rather than buckled ones. Accordingly, the first substrate 110 positioned in the outside based on the center of the curvature radius and the second substrate 210 positioned in the inside based on the center of the curvature radius may be constantly bent to have the same curvature radius, thus maintaining the constant cell gap. Accordingly, it is possible to prevent deterioration of a display quality according to nonuniformity of the cell gap, may occur in the curved display device.

Like the display unit of the curved display device according to the exemplary embodiment described with reference to FIGS. 7 and 8, the regions having different curvature radii may be included according to the position of the curved display device, and the curvature radius may be increased as going toward the edge of the curved display device.

Referring to FIG. 11 again, the backlighting assembly is positioned on a lower portion of the display unit 100 and provides light to the display unit 100. The backlight assembly according to the exemplary embodiment shown in FIG. 11 includes a curved light source module 136, curved optical sheets 122, a curved diffuser 124, a curved reflector 140, a curved bottom chassis 150, and a curved mold frame 160. The curved light source module 136 in the illustrated example includes a plurality of elongated tube like cold cathode lamps (CCFL: cathode fluorescent lamp) configured for emitting light. The plurality of cold cathode lamps may bedisposed in a predetermined direction while a predetermined gap is maintained therebetween along a hypothetical curved surface matching the one or more curvatures of the display 100.

Constituent elements other than the backlight assembly are the same as those of the curved display device according to the exemplary embodiment described with reference to FIG. 10. A specific description thereof will be omitted.

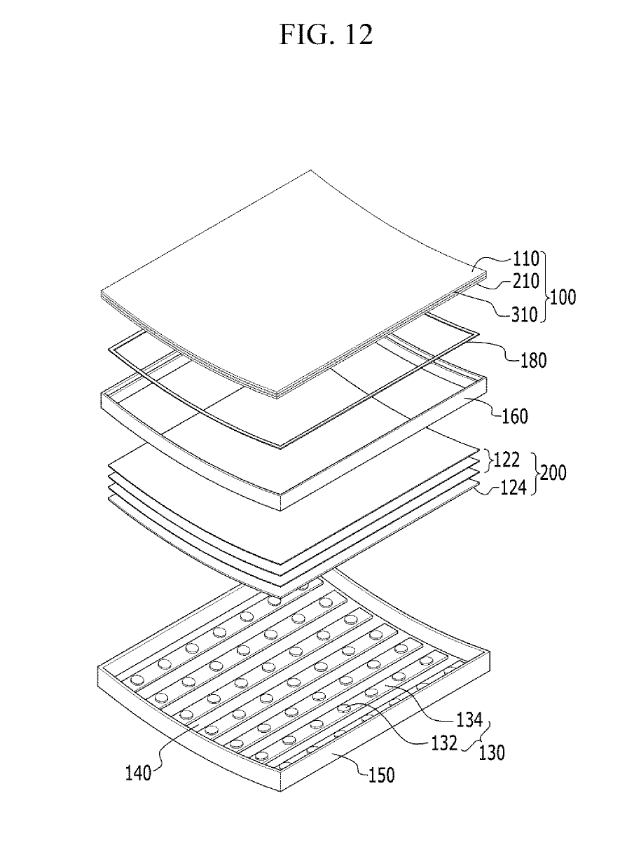

Next, referring to FIG. 12, an example of the curved display device according to the exemplary embodiment of the present invention will be described. FIG. 12 is an exploded perspective view showing another example of the curved display device according to the exemplary embodiment of the present invention.

Referring to FIG. 12, the curved display device according to the present exemplary embodiment includes a direct type backlighting assembly. More specifically, the curved display device includes a direct type backlighting assembly including a plurality of point light sources, for example of a kind configured for supporting block-like selective dynamic backlighting for corresponding block areas of the overall display area.

Specifically, the curved display device according to the present exemplary embodiment includes the curved display unit 100 according to the exemplary embodiment shown in FIGS. 1 and 2, the curved backlight assembly, and the curved fixing member.

The curved display unit 100 includes the bent first substrate 110 and the bent second substrate 210 facing each other, and the shear deformed sealant 310 positioned along the edge of the first substrate 110 and the second substrate 210 to bond the first substrate 110 and the second substrate 210. The first substrate 110 and the second substrate 210 are bent to have a predetermined curvature.

The first substrate 110 positioned in the outside based on the center of the curvature radius and the second substrate 210 positioned in the inside based on the center of the curvature radius are constantly bent to have the same curvature radius. In this case, the center of the curvature radius in the horizontal direction is positioned outside the second substrate 210, that is, at the side at which the observer is positioned.

The sealant 310 has the modulus of elasticity of about 1 MPa to about 100 MPa and more specifically about 1 MPa to about 50 MPa. Like this, the sealant 310 has the modulus of elasticity of about 1 MPa to about 100 MPa, and thus, the sealant 310 can be easily shear deformed at least while the bending processing is being performed so that the first substrate 110 and the second substrate 210 have smoothly curved surfaces rather than buckled ones. Accordingly, the first substrate 110 positioned in the outside based on the center of the curvature radius and the second substrate 210 positioned in the inside based on the center of the curvature radius may be constantly bent to have the same curvature radius, thus maintaining the constant cell gap. Accordingly, it is possible to prevent deterioration of a display quality according to nonuniformity of the cell gap, may occur in the curved display device.

Like the display unit of the curved display device according to the exemplary embodiment described with reference to FIGS. 7 and 8, the regions having different curvature radii may be included according to the position of the curved display device, and the curvature radius may be increased as going toward the edge of the curved display device.

Still referring to FIG. 12, the curved backlight assembly is positioned on a lower portion of the curved display unit 100 and provides light to the display unit 100. The backlight assembly according to the exemplary embodiment shown in FIG. 12 includes a plurality of light emitting diode (LED) packages 132 on which a plurality of light emitting diodes (LED's configured for emitting white and/or colored lights, e.g., RGB) is mounted, and a printed circuit board (PCB) 134 on which the light emitting diode (LED) packages 132 are mounted. A plurality of light emitting diode (LED) packages 132 and the printed circuit board (PCB) 134 are positioned on a curved reflector 140. The reflector 140 is positioned on a lower portion of the light source module 130 to reflect light that is downwardly incident from the light source module 130, thus increasing efficiency of light.

Constituent elements other than the backlight assembly are the same as those of the curved display device according to the exemplary embodiment described with reference to FIG. 10. A specific description thereof will be omitted.

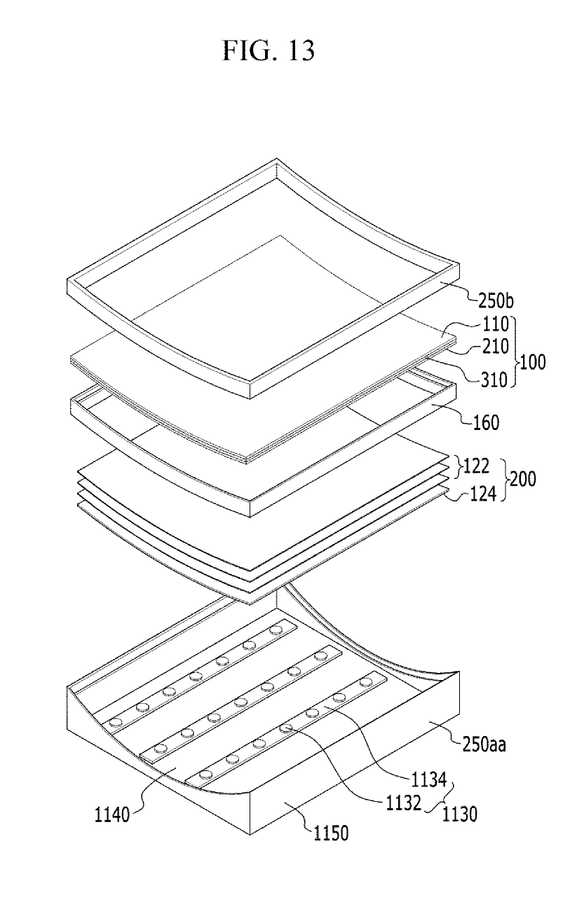

Next, referring to FIG. 13, an example of a mostly curved display device (but with a planar back wall) according to the exemplary embodiment of the present invention will be described. FIG. 13 is an exploded perspective view showing another example of the curved display device according to the exemplary embodiment of the present invention.

Referring to FIG. 13, the curved display device according to the present exemplary embodiment includes a direct type backlighting assembly having a planar back wall. Specifically, the curved display device includes the direct type backlight assembly including the point type light sources.

Specifically, the curved display device according to the present exemplary embodiment includes the curved display unit 100 according to the exemplary embodiment shown in FIGS. 1 and 2, the backlight assembly, and the curved fixing member.

The curved display unit 100 includes the bent first substrate 110 and the bent second substrate 210 facing each other, and the shear deformed sealant 310 positioned along the edge of the first substrate 110 and the second substrate 210 to bond the first substrate 110 and the second substrate 210. The first substrate 110 and the second substrate 210 are bent to have a predetermined curvature.

The first substrate 110 positioned in the outside based on the center of the curvature radius and the second substrate 210 positioned in the inside based on the center of the curvature radius are constantly bent to have the same curvature radius. In this case, the center of the curvature radius in the horizontal direction is positioned outside the second substrate 210, that is, at the side at which the observer is positioned.

The sealant 310 has the modulus of elasticity of about 1 MPa to about 100 MPa and more specifically about 1 MPa to about 50 MPa. Like this, the sealant 310 has the modulus of elasticity of about 1 MPa to about 100 MPa, and thus, the sealant 310 can be shear deformed while the bending processing is being performed so that the first substrate 110 and the second substrate 210 have smoothly curved surfaces rather than buckled ones. Accordingly, the first substrate 110 positioned in the outside based on the center of the curvature radius and the second substrate 210 positioned in the inside based on the center of the curvature radius may be constantly bent to have the same curvature radius, thus maintaining the constant cell gap. Accordingly, it is possible to prevent deterioration of a display quality according to nonuniformity of the cell gap, may occur in the curved display device.

Like the display unit of the curved display device according to the exemplary embodiment described with reference to FIGS. 7 and 8, the regions having different curvature radii may be included according to the position of the curved display device, and the curvature radius may be increased as going toward the edge of the curved display device.

Referring to FIG. 13 again, the backlighting assembly is positioned on a lower portion of the display unit 100 and provides light to the display unit 100. The backlight assembly 1130 according to the exemplary embodiment shown in FIG. 13 includes a backlight assembly that is similar to the backlight assembly according to the exemplary embodiment shown in FIG. 12 except that the PCB's 1134 are arranged on a hypothetical flat plane rather than a curved one. Specifically, the backlight assembly includes a plurality of light emitting diode (LED) packages 1132 on which a plurality of light emitting diodes (LED) emitting light is mounted, and the printed circuit board (PCB) 1134 on which the light emitting diode (LED) packages 1132 are mounted. A plurality of light emitting diode (LED) packages 1132 and the printed circuit board (PCB) 1134 are positioned on a flat reflector surface 1140. The reflector 1140 is positioned on a lower portion of the light source module 1130 to reflect light that is downwardly incident from the light source module 1130, thus increasing efficiency of light. (In place of the smoothly curved reflector embodiment of FIG. 12 and the flat reflector embodiment of FIG. 13 it is also within the contemplation of the disclosure to use a Fresnel-lens like configured reflector that has a plurality of flat regions bent at various angles for piece-wise approximating the curved portions of the curved display 100.)

A bottom chassis 1150 of FIG. 13 is constituted by a flat bottom portion and lateral walls extending from edges of the bottom portion to form a receiving space. Unlike the exemplary embodiment shown in FIG. 12, the bottom portion of the bottom chassis 1150 of the curved display device of the present exemplary embodiment is flat.

Constituent elements other than the backlight assembly are the same as those of the curved display device according to the exemplary embodiment described with reference to FIG. 10. A specific description thereof will be omitted.

As described above, the curved display device according to the exemplary embodiment of the present invention includes the shear deformed sealant 310 positioned at the edges of the bent first substrate 110 and the bent second substrate 210 facing each other to bond the first substrate 110 and the second substrate 210 to each other, and the sealant 310 has the modulus of elasticity of about 1 MPa to about 100 MPa and more specifically about 1 MPa to about 50 MPa. Like this, the sealant 310 has the modulus of elasticity of about 1 MPa to about 100 MPa, and thus, the sealant 310 can be easily shear deformed at least while the bending processing is being performed so that the first substrate 110 and the second substrate 210 have smoothly curved surfaces. Accordingly, the first substrate 110 positioned in the outside based on the center of the curvature radius and the second substrate 210 positioned in the inside based on the center of the curvature radius may be constantly bent to have the same curvature radius, thus maintaining the constant cell gap. Accordingly, it is possible to prevent deterioration of a display quality according to nonuniformity of the cell gap, may occur in the curved display device.

While this disclosure of invention has been described in connection with what are presently considered to be practical exemplary embodiments, it is to be understood that the present teachings are not limited to the disclosed embodiments, but, on the contrary, the disclosure is intended to cover various modifications and equivalent arrangements included within the spirit and scope of the present teachings.

What is claimed is:

1. A curved display device comprising:
a bent first substrate and a bent second substrate spaced apart and facing each other,
a sealant positioned at edges of the first substrate and the second substrate, and
a liquid crystal layer interposed between the first substrate and the second substrate and contained by the sealant,
wherein the first substrate and the second substrate are bent to have almost the same curvature radii at facing subportions thereof and a substantially same cell gap therebetween, and
the sealant is such that it has modulus of elasticity of about 1 MPa to about 100 MPa at least at a time when the first and second substrate are bent into their respective bent configurations.

2. The curved display device of claim 1, wherein:
the modulus of elasticity of the sealant is about 1 MPa to about 50 MPa.

3. The curved display device of claim 1, wherein:
the sealant is shear deformed and has a nonrectangular cross section.

4. The curved display device of claim 3, wherein:
a cell gap between the first substrate and the second substrate is almost constant.

5. The curved display device of claim 4, wherein:
the second substrate is positioned on an inside based on a center of the curvature radius, and
the second substrate is not buckled as compared to the first substrate.

6. The curved display device of claim 5, further comprising:
a curved and rigid fixing member positionally fixing at least corresponding first ends of the first substrate and the second substrate.

7. The curved display device of claim 1, wherein:
the cell gap between the first substrate and the second substrate is almost constant.

8. The curved display device of claim 7, wherein:
the second substrate is positioned on the inside based on the center of the curvature radius, and
the second substrate is not compressed in a horizontal direction as compared to the first substrate.

9. The curved display device of claim 8, further comprising:
a curved fixing member positionally fixing ends of the first substrate and the second substrate.

10. The curved display device of claim 1, wherein:
the second substrate is positioned on the inside based on the center of the curvature radius, and
the second substrate is not compressed in the horizontal direction as compared to the first substrate.

11. The curved display device of claim 10, further comprising:
a curved and rigid fixing member positionally fixing ends of the first substrate and the second substrate.

12. The curved display device of claim 1, further comprising:
a curved and rigid fixing member fixing ends of the first substrate and the second substrate.

13. The curved display device of claim 1, wherein:
the first substrate and the second substrate include a first display region and a second display region, and
the curvature radius of the first display region and the curvature radius of the second display region are different from each other.

14. The curved display device of claim 13, wherein:
the curvature radius of the first display region is larger than the curvature radius of the second display region, and
the first display region is positioned at edges of the first substrate and the second substrate.

15. The curved display device of claim 14, wherein:
the second display region is positioned at central portions of the first substrate and the second substrate, and
the first substrate and the second substrate further include a third display region positioned between the first display region and the second display region, and the third display region has a curvature radius that is different from the curvature radius of the first display region and the curvature radius of the second display region.

16. The curved display device of claim 15, wherein:
the curvature radius of the third display region is smaller than the curvature radius of the first display region and is larger than the curvature radius of the second display region.

17. The curved display device of claim 13, wherein:
the sealant is shear deformed and has a nonrectangular cross section.

18. The curved display device of claim 17, wherein:
the cell gap between the first substrate and the second substrate is almost constant.

19. The curved display device of claim 14, wherein:
the second substrate is positioned on the inside based on the center of the curvature radius, and
the second substrate is not compressed in the horizontal direction as compared to the first substrate.

20. The curved display device of claim 19, further comprising:
a curved and rigid fixing member positionally fixing ends of the first substrate and the second substrate.

21. The curved display device of claim 13, wherein:
the cell gap between the first substrate and the second substrate is almost constant.

22. The curved display device of claim 21, wherein:
the second substrate is positioned on the inside based on the center of the curvature radius, and
the second substrate is not compressed in the horizontal direction as compared to the first substrate.

23. The curved display device of claim 22, further comprising:
a curved and rigid fixing member fixing ends of the first substrate and the second substrate.

24. The curved display device of claim 13, wherein:
the second substrate is positioned on the inside based on the center of the curvature radius, and
the second substrate is not compressed in the horizontal direction as compared to the first substrate.

25. The curved display device of claim 24, further comprising:
a curved and rigid fixing member fixing ends of the first substrate and the second substrate.

26. The curved display device of claim 13, further comprising:
a curved and rigid fixing member fixing ends of the first substrate and the second substrate.
